(19) United States
(12) Patent Application Publication
(10) Pub. No.: US 2010/0066497 A1
(43) Pub. Date: Mar. 18, 2010

(54) TRACKING SYSTEM

(75) Inventors: Andrew Kwang Leng Lim, Singapore (SG); Hong Tze Ng, Singapore (SG); Kim Hung Jeremy Ee, Singapore (SG); Priyadarsan Ghosh, Singapore (SG)

Correspondence Address: Haynes and Boone, LLP;IP Section, 2323 Victory Avenue, SUITE 700, Dallas, TX, 75219, US

(73) Assignee: ST Logistics Pte Ltd, Singapore (SG)

(21) Appl. No.: 12/282,867

(22) PCT Filed: Mar. 2, 2007
(86) PCT No.: PCT/SG2007/000060

§ 371 Date: May 14, 2009

(30) Foreign Application Priority Data
Mar. 14, 2006 (SG) 200601664-6

(51) Int. Cl. H04Q 5/22

(52) U.S. Cl. 340/10.1

(57) ABSTRACT

A system (10) for tracking generic items (20) in a closed loop, the system (10) comprising: a plurality of clients (103), each client associated with a container (104) for containing items (20), each client (103) automatically generating and transmitting item information relating to the items (20) within its associated container (104); and a server (203) to receive the item information from a plurality of clients (103) and to aggregate the circulation of the items (20) in the closed loop, the item information being stored in a database (204) connected to the server (203); wherein the item information comprises: information identifying the client (103); information identifying each item (20) obtained from a RFID tag (25) attached to the item (20) and time each item (20) was placed or removed from the container (104), and information identifying a user which placed or removed an item (20) from the container (104) obtained from a card device (130) of the user.

### TECHNICAL FIELD

The invention concerns a system for tracking generic items in a closed loop.

### BACKGROUND OF THE INVENTION

In a hospital environment, linen management is often overlooked compared to health services. However, its supply is crucial in the public's perception of the quality of patient care provided by the hospital. Currently, most hospitals contract third parties to manage its laundry requirements. However, relationships between the launderettes and hospitals are increasingly strained due to constant linen shortage experienced by hospitals. This problem is attributed to the inability to count soiled linen at both the hospital and launderette. This creates a lack of visibility in this voluminous industry and makes it impossible to establish a trusted and secure linen supply chain between both parties. Without visibility, audit and accountability and the information required to make intelligent decisions are absent. Regular loss of linen occurs unchecked and unnoticed until too late, resulting in the wastage of resources from unnecessary buffering, recurring purchases and valuable time wasted in resolving daily discrepancies.

Present operations can be summarized into the following challenges: linen shortages during operations, no visibility and accountability leading to losses, resource wastage, and uncertainty in arriving stocks which results in high buffering costs.

Linen shortages cause an erratic supply of clean linen. This compromises patient satisfaction and the quality of healthcare services. Consequently, hospitals have received multiple complaints from patients and visitors and this has impacted the perception of the public of the hospitals negatively.

There is no visibility and accountability leading to losses as there is no possible manual method for tracking soiled, particularly contaminated linen that are biohazardous. This has resulted in frequent losses, with neither party able to be held responsible.

Resource wastage may occur by attempting to resolve linen discrepancies. Such resolution requires significant effort from the healthcare assistants and nurses. Therefore, attention is often diverted from the primary purpose of providing care to patients and instead spent on searching for linen replacements from the various launderettes and hospitals. Opportunity cost and other costs are associated with this unproductive activity. Other costs include the labour and transportation charges that are incurred to rectify the daily discrepancies in linen operations.

Uncertainty in arriving stocks results in high buffering costs. With such uncertainty, it is difficult to anticipate and plan for optimal linen operations. Hospitals have had to purchase buffer stocks of linen to anticipate the daily shortages in an attempt to address this uncertainty. Currently, it is estimated that more than 6 par levels of linen stocks is kept, increasing the yearly capital expenditure spent on linen.

The disadvantages of existing linen management techniques are numerous, including: the inability to count soiled linen (a biohazard material), the lack of accountability during handing over processes, shortage of linen causing patient dissatisfaction, linen used by patients or sent to launderette are not returned, possibility of pilferages and losses, and the uncertainty in projecting short and long term linen stock levels.

Therefore, there is a desire for a linen management system that automatically tracks soiled and clean linen items continuously through the entire linen cycle. It is desirable to lower the quantity of buffer linen stock at hospitals while also achieving predetermined service quality standards.

### SUMMARY OF THE INVENTION

In a first preferred aspect, there is provided a system for tracking generic items in a closed loop, the system comprising:
a plurality of clients, each client automatically generating and transmitting item information relating to the items identified by the client; and
a server to receive the item information from a plurality of clients and to aggregate the circulation of the items in the closed loop, the item information being stored in a database connected to the server;
wherein the item information comprises:
information identifying the client;
information identifying each item obtained from a Radio Frequency Identification (RFID) tag attached to the item and time each item was identified by a RFID reader operatively connected to the client, and
information identifying a user causing the RFID tag to be identified.

The RFID reader may be operatively connected to at least one RFID antenna that is provided in a container, the container for containing items, and when items are placed or removed from the container, the RFID tags of all items contained in the container are identified.

The RFID reader may detect multiple RFID tags of multiple items at the same time.

The items may be items of linen used in a hospital or hotel.

The system may further comprise an administration client module for configuring the system and associating items and associated items details information on the server with RFID tag identification codes, the item details information including the name and type of the item, the size of the item, the date of purchase of the item, the purchase price of the item, and also for configuring security features including user access rights and data view restrictions.

The server may comprise a report management module to provide predetermined reports on the status of items, the predetermined reports being any one from the group consisting of: dwell time of stationery items, usage of the items, age of the items, location of items according to the type of an item, average circulation time according to the type of an item, movement history of an item, total stock breakdown of items, current stock by item, current stock by zone, current stock by location type, item wash count summary, items transacted by users, and decommission by time period report.

The server may comprise an electronic invoicing module to enable service providers to charge differentiated rates by service types or Stock Keeping Units (SKUs), or on time of delivery/turnaround time.

Invoice generation may be automated and based on information collected from reading the RFID tags of the items.

The server may comprise a dashboard module that retrieves the item information from the database to provide a real-time snapshot of inventory counts of each Stock Keeping Unit (SKU) at predetermined locations in the closed loop.

Items identified by the RFID reader may be stored in a local database of the client to enable off line audit and cycle counts.

The system may be fully automated and is a paperless transaction system without manual keyboard entry for recording the movement of items in the closed loop.

The information identifying a user may be obtained from a card device of the user using a card device reader operatively connected to each client.

The card device may be a contactless smart card.

Each card device may have a unique identification code, each identification code being associated with a user.

The information identifying the client may be associated to the location of the RFID reader.

Each RFID tag may have a unique identification code, each identification code being associated with a specific item of linen.

The clients may be classified into predetermined groups according to logic, process step, or location.

The server may comprise an alert management module to create alerts and view created alerts.

An alert may be any one from the group consisting of: low inventory levels of a type of item at a location, repeated failure of a user to identify themself when causing the RFID tag to be identified, if a specific node or process is skipped, and no movement of an item from a location for a predetermined period of time.

System may be provided based on an Application Service Provider (ASP) model, the database and the server being hosted by an application service provider.

The system may monitor multiple enterprises and supply chains at the same time.

Revenue may be generated by the system using a transaction model or lease model.

In a second aspect, there is provided a client for tracking generic items in a closed loop, the client comprising:
a data capture module to capture identification information from RFID tags attached to the items and identification information from a card device of a user;
a data processing module to associate the identification information of the RFID tags and card device with the time the identification information was captured and identity of the client; and
a data transmission module to transmit the data processed by the data processing module to a data receiving module at a server to aggregate the circulation of the items in the closed loop from multiple clients.

The data capture module may be operatively connected to an RFID reader to capture identification information from the RFID tags.

The RFID reader may be operatively connected to at least one RFID antenna that is provided in a container, the container for containing items, and when items are placed or removed from the container, the RFID tags of all items contained in the container are identified.

The RFID reader may be a RFID scanner device such as a 3D scanner, tunnel/chute type RFID antenna, tabletop scanner or a handheld RFID scanner.

The data capture module may captures the identification information when items are placed into or removed from the container.

RFID middleware may be provided to filter unique reads from the RFID reader per scan and to associate each scan with a card device of a user performing the scan.

The card device may be a contactless smart card.

In a third aspect, there is provided a container for containing linen items operatively connected to a client for tracking the linen items in a closed loop, the container comprising:
a plurality of antennas to detect RF signals emitted by RFID tags attached to the linen items contained in the container; and
a multiplexer to multiplex the RF signals for transmission to an RFID reader;
wherein each of the plurality of antenna is positioned in the sidewall of the container at a predetermined position to improve detection accuracy of the RFID tags attached to the linen items contained in the container.

The client may comprise RFID middleware to filter unique reads from the RFID reader per scan and to associate each scan with a card device of a user performing the scan.

In a fourth aspect, there is provided a server for tracking generic items in a closed loop, the server comprising:
a data receiving module to receive item information from a plurality of clients; and
an aggregation module to aggregate the circulation of the items in the closed loop based on the received item information;
wherein the item information comprises:
information identifying the client;
information identifying each item obtained from a Radio Frequency Identification (RFID) tag attached to the item and time each item was identified by a RFID reader operatively connected to the client, and
information identifying a user causing the RFID tag to be identified.

A report management module may be provided to provide predetermined reports on the status of items, the predetermined reports being any one from the group consisting of: dwell time of stationery items, usage of the items, age of the items, location of items according to the type of an item, average circulation time according to the type of an item, movement history of an item, total stock breakdown of items, current stock by item, current stock by zone, current stock by location type, item wash count summary, items transacted by users, and decommission by time period report.

The client may comprise:
a data capture module to capture identification information from RFID tags attached to the items and identification information from a card device of a user;
a data processing module to associate the identification information of the RFID tags and card device with the time the identification information was captured and identity of the client; and
a data transmission module to transmit the data processed by the data processing module to the data receiving module at the server to aggregate the circulation of the items in the closed loop from multiple clients.

### BRIEF DESCRIPTION OF THE DRAWINGS

An example of the invention will now be described with reference to the accompanying drawings, in which:

FIG. 1 is a network diagram of a tracking system in accordance with a preferred embodiment of the present invention;

FIG. 2 is a system diagram of a client of the tracking system of FIG. 1;

FIG. 3 is a system diagram of a server of the tracking system of FIG. 1;

FIG. 4 is a pictorial diagram of an item, RFID tag and container in accordance with a preferred embodiment of the present invention;

FIG. 5 is a process flow diagram of a closed loop for the tracking system of FIG. 1;

FIG. 6 is a block diagram of the scalability of the tracking system of FIG. 1;

FIG. 7 is a Total Stock Breakdown By Item By Status report;

FIG. 8 is a Average Laundry Turnaround report;

FIG. 9 is a Daily Laundry Check-In/Check-Out report;

FIG. 10 is a Item Wash Count Summary report; and

FIG. 11 is a Safety Stock Level report.

### DETAILED DESCRIPTION OF THE DRAWINGS

The drawings and the following discussion are intended to provide a brief, general description of a suitable computing environment in which the present invention may be implemented. Although not required, the invention is described in the general context of computer-executable instructions, such as program modules, being executed by a computer such as a personal computer, laptop computer, notebook computer, tablet computer, PDA and the like. Generally, program modules include routines, programs, characters, components, data structures, that perform particular tasks or implement particular abstract data types. As those skilled in the art will appreciate, the invention may be practiced with other computer system configurations, including hand-held devices, multiprocessor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

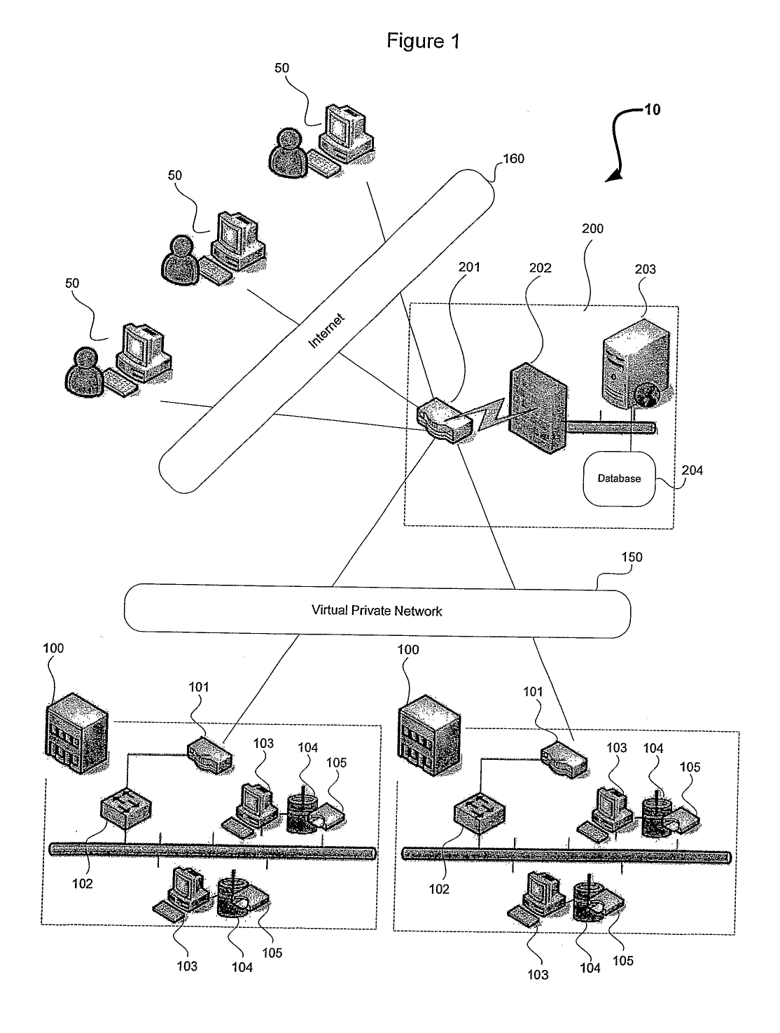

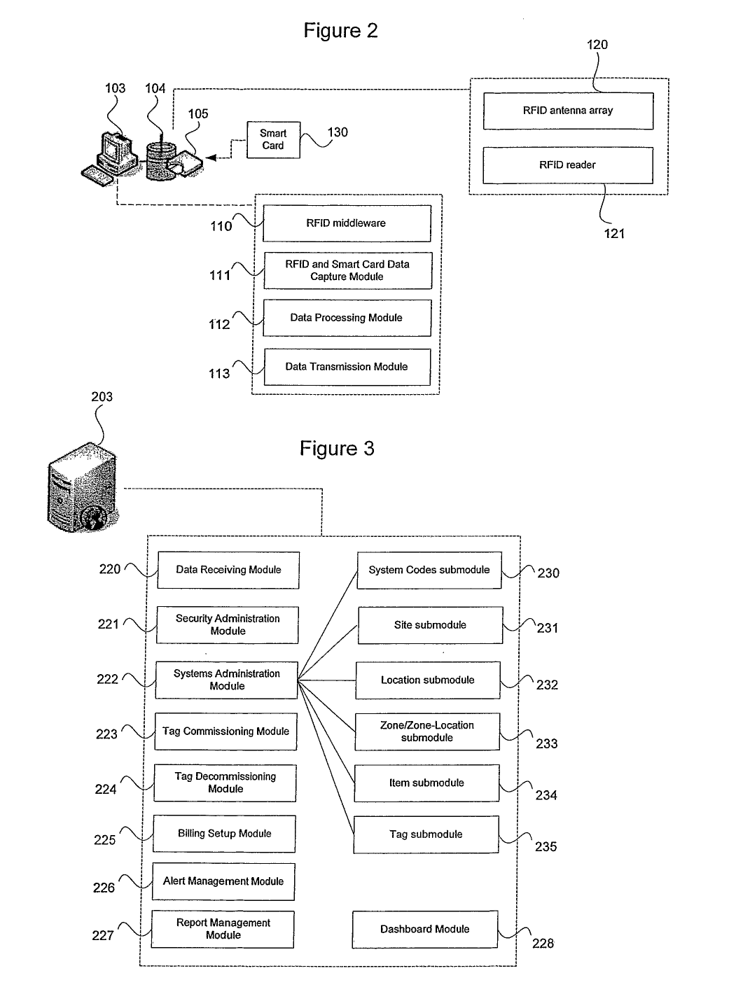

Referring to FIGS. 1 to 3, a system for tracking generic items 20 in a closed loop is provided. In one embodiment, the items 20 are items of linen used in a hospital or hotel. The system comprises: a plurality of clients 100 in communication with a server 203 residing at the server side 200 via a Virtual Private Network 150. The server 203 is protected by a firewall 202 coupled to a router 201 for network communication. The system is fully automated and is a paperless transaction system without manual keyboard entry for recording the movement of items 20 in the closed loop.

Workstations 50 or portable communications devices may access the server 203 via the Internet/Intranet to generate and obtain reports and alerts on items 20 in the closed loop.

Each client site 100 may service multiple clients 103, each client 103 associated with a RFID antenna 120 located in a container 104 for containing items 20. The clients 103 may be classified into predetermined groups according to logic, process step, or location. Each client site 100 has a router 101 for network communication with the router 202 on the server side 200. The router 101 is operatively connected to a N/W switch 102 to communicate with multiple clients 103. Each client 103 automatically generates and transmits item information relating to the items 20 within its associated container 104, when a user has placed or removed items 20 from the container 104. A display device may be provided to visually indicate and confirm data capture from the Radio Frequency Identification (RFID) tags 25 of the items 20 placed into and removed form the container 104, to the user.

An RFID reader 121 is provided to the container 104 to read RFID tags 25 attached to items 20 placed within the container 104. Each RFID tag 25 has a unique identification code. Each identification code is associated with a specific item of linen 20. The RFID reader 121 retrieves the unique identification code of each RFID tag 25 it detects. As multiple linen items 20 may be entangled, folded, or crushed, the RFID reader 121 uses a three dimensional antenna configuration 120 to improve reading accuracy of the RFID tags 25. For example, three antennas 120 may be positioned at predetermined positions in the sidewall of the container 104 to optimize reading accuracy covering all the three axes. A multiplexer then multiplexes the signals received by the antennas 120 and transmits it to the RFID reader 21. The RFID reader 121 is operatively connected to each client 103.

A card device reader 105 is operatively connected to each client 103 to read the card device 130 of the user. The card device 130 may be a contactless smart card (CSC) 130 (for example, with an inbuilt RFID antenna) allocated to each user in the system 10. Each smart card 130 has a unique identification code uniquely associated to a user.

The server 203 receives the item information from the client sites 100 and aggregates the circulation of the items 20 in the closed loop. The item information is stored in a database 204 connected to the server 203. The item information comprises: information identifying the client 100, information identifying each item 20 obtained from an RFID tag 25 attached to the item 20 and the time each item 20 was placed or removed from the container 104, and information identifying a user which placed or removed an item 20 from the container 104 obtained from the smart card 130 of the user. The information identifying the client 100 is associated to the location of the container 104. Each RFID tag 25 has a unique identification code. This unique identification code is associated with other data related to the item 20 such as the name and type of the item 20, the size of the item 20, the date of purchase of the item 20, and the purchase price of the item 20.

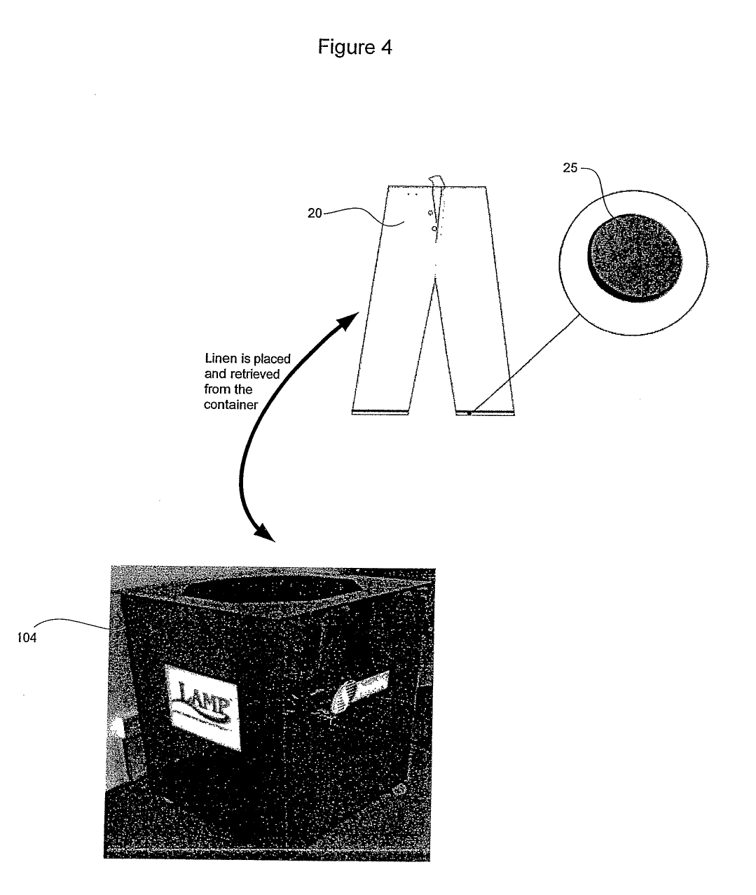

Referring to FIG. 4, in a hostile environment such as a hospital and launderette, the RFID tag 25 used must be able to withstand heat and pressure from the washing process and chemicals such as washing detergents, repeatedly. A Logi Tag 160H was selected for the RFID tag 25. It has an I-Code 512 bit R/W chip type, and has a diameter of 16 mm with a thickness of 3 mm. The Logi Tag 160H™ has been tested to operate for the following laundry process: washing 40 minutes (12 minutes at 90° C.), water press extraction 20 bars 3 minutes, spin dryer 10 minutes 175° C. and tunnel finisher 10 minutes 175° C. The RFID tag 25 is attached to a specific location on the item 20 to avoid discomfort to the user wearing the linen item 20. The location also takes into consideration durability and accuracy of reading the RFID tag 25. For example, for trousers 20, the RFID tag 25 is sewn into a trouser leg.

The system 10 is a web-based system 10 for managing the flow of linen 20 between the customer (hospital, hotel or a country club), the launderette and the distribution centres (DC) using RFID tags 25 attached to linen items 20. Preferably, the system 10 is a .NET™ architecture. The system 10 generally comprises a non-user intervention windows-based client 100 for transactions linking to a RFID Bin Reader/Access Card Controller 121, a user intervention windows-based client 50 for setting up of base parameters and transactions requiring user's intervention, and a browser-based client 50 for reporting and query. Some clients 50 may have an administration client module installed for configuring the system 10 and associating items 20 and associated items details information on the server 203 with RFID tag identification codes. The item details information include the name and type of the item, the size of the item, the date of purchase of the item, the purchase price of the item. The administration client module is also for configuring security features including user access rights and data view restrictions.

The browser-based client 50 is a navigator providing a tree-like structure view of a complete list of main modules 221, 222, 223, 224, 225, 226, 227 and its respective sub-modules within the application on the system 10. By clicking the ‘-’ sign, sub-modules are expanded and also the subsequent levels. Clicking the sign collapses (hides) the sub-modules of a module. To open the submodule, the respective item 20 in the expanded list is double-clicked.

The modules 221, 222, 223, 224, 225, 226, 227 of the system 10 are:

| Module | Description |
|---|---|
| Security Administration | Allows for the setting up of Enterprise, Roles, |
| 221 | Users and the assignment of role-based access |
| | rights |
| Systems Administration | Allows for the creation of master tables such as |
| 222 | Site, Location, Zone, Item and Tag. It also |
| | consists of a submodule which allows users |
| | to define variables used by the system 10 |
| Tag Commissioning 223 | Allows for Tags 25 to be initialized and be |
| | associated with Items 20 |
| Tag Decommissioning | Allows for Tags 25 to be de-associated with |
| 224 | Items 20 |
| Billing Setup 225 | Allows for billing method to be set up |
| Alert Management 226 | Allows for setting up of alerts and viewing of |
| | alerts |
| Report Management 227 | Allows for the generation of standard and |
| | customized reports |
| Dashboard 228 | Provides real-time view of individual SKU |
| | (Stock Keeping Unit) counts at various |
| | locations in the supply chain |

In the Security Administration module 221, there is Enterprise Profile, Role Profile, User Profile, Card Access Profile, and Module Management.

The ‘Enterprise Profile’ table contains basic information on the supply chain that is used by the browser-based client 50. Each Enterprise is uniquely identified by an Enterprise ID.

Role Profile allows the System Administrator to create different roles in the supply chain and assign the corresponding access rights. By default, a role is granted full access rights unless explicitly restricted based on Functionality or by Data (that is, restriction based on Sites). Roles created can then be assigned to one or more Users in User Profile.

User Profile allows the System Administrator to create user and assign the corresponding access rights. Access rights can be assigned to a user by assigning it roles which have already been defined in Role Profile. One or more roles can be assigned to the User and the system will take the union of different roles assigned. Access rights can also be granted based on Functionality and Data Restriction at the user level. By default, a user is granted full access rights without restriction. This module also allows the authorized user to assign which alerts the user can view.

Card Access Profile allows the System Administrator to configure the RFID access card 130 for either the staff within the Sites or the Transporters who ferry the items 20 between the Sites. For Issue, the card 130 is associated to a Site and Location to which the tags 25/items 20 are to be issued to. For Check In/Check Out, the card 130 captures information of the users who perform the check in/check out operations at various sites.

Module Management allows a user to modify the function modules names and indicate their preferred Module form page image and icon image. The module can be manually indicated the specific sequence location.

The Systems Administration module 222 comprises submodules including: a System Codes module 230, Site module 231, Location module 232, Zone/Zone-Location module 233, Item module 234 and Tag module 235.

The System Codes module 230 allows the System Administrator to set up the system variables which can be referred by other modules in the application. Each System Code has a header and a detail level, and has a unique identifier. It can be associated with one or more possible values and each value will have a ‘Display Text’ which is used to displayed on screen.

The Site module 231 allows System Administrator to set up the various Site (or Nodes) within the supply chain. Each Site will have a unique ‘Site Id’ within the Enterprise and ‘Site Type’ which possible values can be ‘Hospital’, ‘Launderette’ or ‘Hotel’. These values can be defined by the user in the System Codes module 230. A Site can have either an ‘Active’ or ‘Inactive’ status. Items going into ‘Inactive’ site is logged in the exception report.

The Location module 232 allows user to set up the different types of locations within the Site. Each location will have a unique ‘Site Id’ within the Site and a ‘Location Type’ which can be used to indicate if the location is the ‘Main Store’, ‘Check In’ or ‘Check Out’ location. These values can be defined by the user in the System Codes module 230. A location will also have either an ‘Active’ or ‘Inactive’ status. Locations can be assigned to one or more zones to facilitate efficient operations.

The Zone/Zone-Location module 233 allows System Administrator to create zones and logically associate a collection of locations to a zone. By ‘logically’, this means that the zoning is only valid and applicable within the browser-based client 50 and the site need not be physically zoned to reflect the setting. Locations can be re-zoned. Each zone will have a unique ‘Zone Id’ within the Site.

An Item 20 refers to an individual linen component that is tagged in the system 10. The Item module 234 allows a System Administrator to create items 20 for a particular Site that owns the items 20. Each item 20 will have a unique ‘Item Id’ within the Site and a ‘Status’ which indicating the state of the item, example, ‘In Stock’, ‘In Transit’ or ‘In Laundry’. These ‘Status’ are configurable in the ‘System Code’ table. Each item 20 can have both ‘Static’ (e.g. if different product codes for different sizes, then one of the static fields is used to define size) and ‘Dynamic’ (e.g. if different batch of items to be commissioned might be from different vendor and this information is important, then the System Administrator defines Supplier as one of the dynamic track attributes) attributes attached to it. Each item 20 also has an item-level safety stock quantity and one or more location-level safety stock quantities. Such information is used in alert if the stock level for the item 20 falls short of the safety level set. Alerts are handled by the Alert Management Module 226 described later.

The tag module 235 allows the user to register new tags 25 and to view the list of tags 25. The Tag History tab shows the list of tags 25 that have been decommissioned. The system 10 allows the tags 25 to be registered individually or in batch if the range of Tag IDs is known. When a tag 25 is first registered, the ‘Tag Status’ is ‘Open. The possible values of the Item Status are shown in table later.

Each item 20 is tagged with an RFID chip 25 having a unique identifier. The RFID chip 25 enables tracking of the location and status of the item 20 associated with it. The RFID chip 25 has the following status at any one time and with combination of this status and location, the system 10 is able to determine the Item Status as follows:

| Status | Description |
|---|---|
| Commission | This is the initial state of a tag when it is first attached to an |
| | item. Information pertaining to the item, such as hospital, ward, |
| | item code, item description, item attributes (supplier, batch no., |
| | purchase date etc.) is captured prior to the commissioning process. |
| Clean | This status is assigned at the point when the item/tag is out of |
| | the cleaning process, i.e. check out of Launderette. The wash |
| | count is incremented whenever the status is changed from |
| | ‘Soiled’ to ‘Clean’. The last wash date is captured at the same time. |
| Soiled | This status is assigned to an item/tag that has been dropped into the |
| | collection point to be sent to Launderette. |
| Open | This status is the initial state of the tag that is not tagged to an item but |
| | registered in the system for tracking of tags. |
| Decommission | This status is assigned to the tag when it is detached from the |
| | item during the decommissioning process. This condition is |
| | applicable to normal decommissioning, for the case whereby |
| | the tag is non-functional or item is lost, during the |
| | decommissioning process, user can specify the reason code |
| | and the status is updated to ‘Lost’ or ‘Damaged’ accordingly. |
| Lost | This status is assigned to a tag that is lost. The status has to be |
| | manually updated (as the tag is lost and cannot use the RFID |
| | reader to read the tag) for those tags identified as lost. |
| Damaged | This status is assigned to a tag that can not be used anymore. |
| | The status has to be manually updated (as the tag is damaged |
| | and not readable by the RFID reader). |

The following table indicates which process causes the corresponding change in Tag Status. The transitions from the ‘From Tag Status’ to the ‘To Tag Status’ are described as follows:

| To Tag Status | Process causing the change in status |
|---|---|
| Open | NA since Open is not a system-assigned state |
| Commission | Tag Commissioning |
| Clean | Check-in to Hospital |
| Soiled | Check-out from Hospital |
| Decommission | Tag Decommissioning |
| Lost | Tag Decommissioning |
| Damaged | Tag Decommissioning |

The tag commissioning module 223 initializes and associates Tags 25 with Items 20. Commissioning a tag 25 refers to the process of reading the Tag ID that comes with the tag 25 (as per manufacturer) and associating it with a system-generated serial number. The purpose of this serial number is for the system to track the item when the tag is un-associated to the item.

The tag 25 to be commissioned can be of any status. However, the process of commissioning will differ according to the ‘Tag Status’ of the tag 25. After a tag 25 is commissioned, the ‘Tag Status’ becomes ‘Commission’.

The Tag Decommissioning module 224 allows for Tags 25 to be de-associated from Items 20. Decommissioning a tag 25 refers to the process of de-associating a tag with an item. The tag 25 can be decommissioned because it is to be reused for another item, or it can be damaged or lost. When a tag 25 is decommissioned because of damage or lost, the user has to manually update the status with a reason code. History of the tag 25 is kept in the system after it is decommissioned. The Decommission Tag module 224 allows the user to decommission one or more tags 25 at a time.

The Check In and Check Out Processes are described. For the Check In and Check Out Processes, the following components are used: Users' RFID Card 130, POS Reader 105 and RFID reader 121. The user is issued with a dedicated RFID card 130 to identify his user id, user name and particulars to initiate the POS and BIN reading process. A dedicated POS reader 105 is provided at each check-in/check-out station. When the user's RFID card 130 is tapped on the POS reader 105, the user information is captured and he is logged in. A second tap on the POS reader 105 will terminate the POS read process and logs out the user. Each POS reader 105 is associated with a RFID reader 121. To register a check in/out, the user has to place the laundry bag in the container 104 after he is logged in. The RFID reader 121 of the container 104 then reads the tag 25 on each item 20.

Both the check-in and check-out workflow processes are similar, except that the check out program will set the tag status to either ‘Soiled’ or ‘Clean’ depending on whether the site is a ‘Hospital’ or a ‘Launderette’. The check-in program, on the other hand, does not change the tag status. The following table describes these different scenarios:

| Site | Process | Tag Status | Location Type |
|---|---|---|---|
| Hospital | Check out | Soiled | InTransit |
| Launderette | Check in | Soiled | CheckIn |
| Launderette | Check out | Clean | In Transit |
| Distribution Centre | Check in | Clean | CheckIn |
| Distribution Centre | Check out | Clean | In Transit |
| Hospital | Check in | Clean | CheckIn/Main |

RFID middleware 110 is provided at the client 103 to filter unique reads from the RFID scanner 121 and also associate each scan to the user's smart card 130. The activation of the RFID middleware 110 is either by clicking on the start button of the program for commissioning and decommissioning or detecting of the card 130 at the card reader 130 for Check In/Check Out/Issue/Audit operations. The RFID middleware 110 also calls a first API command to turn on the yellow light of the LED on the container 104 to signal that the items 20 can be placed in the container 104 to be read by the RFID reader 121. Once the process is initiated, the RFID middleware 110 calls a second API command for each antenna 120 by calling a third API command (to set the antenna 120) first. This is repeated every three seconds to detect new tags 25 in the container 104 using the RFID reader 121. The program calls the first API command to turn on the red light of the LED on the container 104 to notify user that the scanning process is going on. The RFID middleware 110 calls a fourth API command once there is a new tag found status returned by the second API command and waits for the list of tags to be returned. Once the RFID middleware 110 receives the array of tags returned, it calls the first API command to turn on the yellow light of the LED on the container 104 to signal that the next batch or bag of items 20 can be placed for scanning. The RFID middleware 110 repeats the steps of calling the second API command for each antenna 120 and calling the fourth API command and first API command until the end of the process. The end of the process is notified by either clicking on the end button of the program for commissioning and decommissioning, or detecting of a card 130 at the card reader 105 for Check In/Check Out/Issue/Audit operations.

The client 103 also comprises a data capture module 111 to capture identification information from RFID tags 25 attached to the items 20 and identification information from the card 130 of a user. A data processing module 112 associates the identification information of the RFID tags 25 and the card 130 with the time the identification information was captured and identity of the client 130. This information is also stored in a local database of the client 103 to enable off line audit and cycle counts. A data transmission module 113 transmits the data processed by the data processing module to a data receiving module 220 at the server 203 to aggregate the circulation of the items 20 in the closed loop from multiple clients 103.

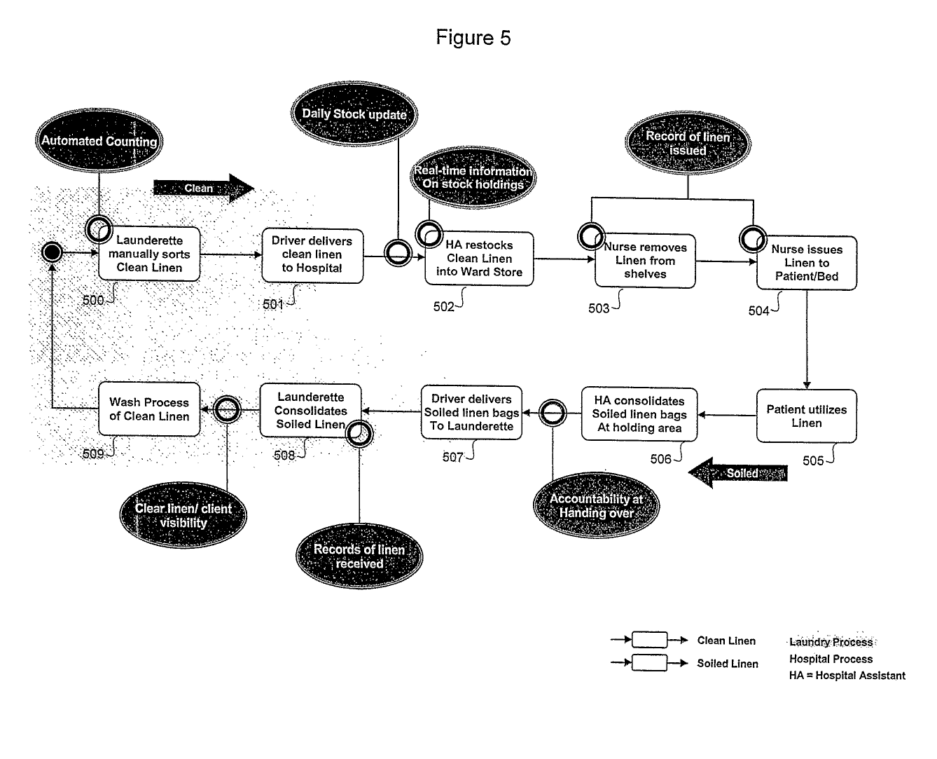

Referring to FIG. 5, the closed loop for the system 10 is illustrated. The clean portion of the closed loop is at the top of the loop. The launderette manually sorts clean linen (step 500). All clean linen items are automatically counted at the launderette by reading the RFID tags 25. Next, the user for the launderette delivers clean linen to the hospital (step 501). A daily stock update is performed by the hospital by reading the RFID tags 25 and real-time information on stock holdings is obtained. The Hospital or Healthcare Assistant (HA) restocks clean linen into the ward store (step 502). Steps 3503 and 504 are repeated. The nurse removes the linen 20 from the shelves (step 503) and the RFID tag 25 are read and the smart card 130 of the nurse who removed it is also read. The nurse issues the linen 20 to the patient or bed (step 504). The patient utilizes the linen 20 (step 505). Next, the soiled portion of the closed loop is at the bottom of the loop. The HA consolidates the soiled linen bags at a holding area (step 506). The RFID tags 25 of the soiled linen 20 in the soiled linen bags are detected and recorded. There is accountability when the HA hands over the soiled linen bags to the user of the launderette. The user delivers the soiled linen bags to the launderette (step 507). The launderette consolidates the soiled linen (step 508) and the soiled linen items 20 are recorded by the launderette by reading the RFID tags 25. The linen items 20 are washed (step 509). The loop restarts again for the linen items 20. At multiple steps in the loop, the linen items 20 are detected, counted and recorded. This enables accurate tracking of the linen items 20 in the loop. Real-time inventory positions of items 20 at multiple locations may be displayed. The server 203 receives the item information from the clients 103 at the client sites 100 and aggregates the circulation of the items 20 in the closed loop. The item information is stored in a database 204 connected to the server 203. By aggregating the asset turns of the items 20 in the closed loop, complex reports may be generated and intelligent alerts may be configured. Previously, this was not possible and thus high inventory levels were required, and accountability was significantly lacking. Dwell time of stationary linen items 20 may be calculated. This may be used to reconcile items 20 that may have gone missing or stolen. Electronic invoicing by service providers (laundrettes) is enabled using an electronic invoicing module. Electronic invoicing minimises billing inaccuracies. Previously, billing inaccuracies were running at approximately 30 to 40% undercharged by the laundrettes to the hospital. Advantageously, the system 10 identifies each item 20, adds intelligence to it and follows a controlled work flow process to derive maximum benefits for the users.

The system 10 may provided based on an Application Service Provider (ASP) model. The database 204 and the server 203 are hosted by an application service provider. Revenue is generated by the system using a transaction model (pay per use) or lease model (per volume of transactions or number of seats). The system 10 is able to monitor multiple enterprises and supply chains at the same time.

The checking-in and checking-out an item 20 procedure is as follows:
1) For the respective transaction, edit the configuration file with the following values under local client settings:

| | Transaction | | |
|---|---|---|---|
| Transaction | Type | SiteID | LocationID |
| Check In Hospital | In | Hospital | CheckIn/Main |
| Check Out Hospital | Out | Hospital | CheckOut |
| Check In Launderette | In | Launderette | CheckIn |
| Check Out Launderette | Out | Launderette | CheckOut |
| Check In DC | In | DC | CheckIn |
| Check Out DC | Out | DC | CheckOut |

2) To start the Check In/Out process, tap the RFID card 130 on the appropriate POS reader 105
3) The system 10 will display the Card ID read from the RFID card 130 and will prompt the user to commence the scan process
4) Observe the Light Emitting Diode (LED) on the container 104. A change in colour will visually indicate when scanning is in progress or has completed.
5) Place the laundry bag of linen items 20 into the container 104. The scanning process of the RFID reader 121 is started automatically. Once scanning is complete, the system 10 will prompt the user to remove the bag.
6) Place the next bag. Repeat Steps 5 and 6 for more bags.
7) Once the bags are all deposited and scanned, tap the RFID card 130 on the POS reader 150 to end the RFID reader 121 read process.
8) Observe that the container's 104 LED to visually indicate that scanning and reading is completed.

Items 20 can be issued from the Check In or Main Store to the Wards within the Hospital. The tag status is changed to ‘Issued’ when the item 20 is issued. Re-issuance of items 20 between wards is also allowed.

When an item 20 is moved between locations of different types, its item status is updated according to the Site ID, Tag Status and Location Type. The scenarios are described as follows:

| | To | | | |
|---|---|---|---|---|
| | Location | Tag | | Handled by |
| Site Type | Type | Status | Item Status | Process . . . |
| Hospital | Check Out | Soil | In Transit to | Check out from |
| | | | Launderette | Hospital |
| Launderette | Check In | Soil | In Launderette | Check in to |
| | | | | Launderette |
| Launderette | Check Out | Clean | In Transit from | Check out from |
| | | | Launderette | Launderette |
| DC | Check In | Clean | In DC | Check in to |
| | | | | Launderette |
| DC | Check Out | Clean | In Transit from DC | Check out from |
| | | | | Launderette |
| Hospital | Check In | Clean | In Stock | Check in to |
| | | | | Hospital |
| Hospital | Ward | Issue | In Use | Issue Item |

Each location is assigned a location type. It indicates whether the item 20 is ‘In Store’, ‘In Ward’, ‘At Check In Station’ or at ‘At Check Out Station’. The following table shows the Location Type and when it is updated:

| Location | |
|---|---|
| Type | Updated when |
| Main | Item 20 is moved to any user-defined location which stores |
| | the Store item 20. The item 20 is assumed to be ‘Clean’ |
| Ward | Item 20 is moved to any user-defined location which |
| | consumes Store the item 20. The item 20 is assumed to be |
| | ‘Issued’ |
| Check In | Item 20 is at the check-in station of the site. The item 20 can |
| | be ‘Clean’ or ‘Soiled’ depending on the Site Type |
| In Transit | Item 20 is moved to the check-out station of the site. The item |
| | 20 is assumed to be physically out of the site soon after the |
| | tag status is updated. The item 20 can be ‘Clean’ or ‘Soiled’ |
| | depending on the Site Type The item 20 can be ‘Clean’ or |
| | ‘Soiled’ depending on the Site Type |

There is a dedicated POS reader 105 at each location. Only the POS reader 105 in the main store is associated with a RFID reader 121. The POS reader 105 serves to initiate the item movement process while the RFID reader 121 is used to read the tags 25 on the items 20 as the laundry bags are placed into the container 104.

Each user, for example, staff within the hospital, is issued with RFID cards 130 for every ward location within the hospital. Each RFID card 130 has a unique ID which identifies the staff and the location. These RFID cards 130 serve to identify the location which the items 20 are moved into (the ‘To Location’). At each location, the staff uses the RFID card 130 to initiate the issue process and scans the items 20 which are to be moved out of the location into a new location. Consistent failure to follow procedure and use the RFID card 130 for check-in and check-out is alerted and the user is warned or undergoes additional training.

The number of times the status of the tag 25 is changed from ‘Soiled’ to ‘Clean’. The Last Wash Date is captured at the same time.

Items 20 are issued from the Main Store in accordance with the following steps:

1) For the respective transaction, edit the configuration file with the following values under local client settings:

| Transaction | Transaction Type | SiteID | LocationID |
|---|---|---|---|
| Issue From Check In | ISS | Hospital | Check In |
| Issue From Check In | ISS | Hospital | Main Store |

2) Get the RFID card 130 which is tagged with the Ward's location id
3) Prepare a client 103 to serves as an ‘Issue’ station, edit the configuration file with the following values under client 103 setting:
Transaction Type=‘ISS’.
SiteID=<any hospital id>.
LocationID=<‘Main Store’/‘Check In’ location of the hospital>.
   4) Tap the RFID card 130 on the POS reader 105 in the Main Store.
   5) Place the items 20 to be issued into the container 104 to be read by the RFID reader 121.
   6) After scanning is done, remove items 20 from the container 104.
   7) Repeat Steps 4 and 5 for a few more items 20 that are to be issued to the Ward.
   8) Tap the RFID card 130 on the POS reader 105 to end the read process of the RFID reader 121.

The Billing Setup module 225 handles multitier rates, Tax Group and Tariff. Multi-tier rates allow the user to define infinite levels of different rates for different quantity of items 20 handled. This function can also handle time related billing, that is, different rates for different time periods. The Multi-Tier Rates Types can be: Multi Rate—Quantity, Single Rate—Quantity, and Single Rate—Time. “Single rate” means that the system 10 looks at the range in which the quantity falls in and applies the corresponding rate. In contrast, “Multi rate” means that the system 10 applies different tier rates to the quantity, for those quantities less than the specific quantity.

Tax Group allows the user to group one or more Tax Codes. Tariff allows the user to define the tariff details such as the Tariff Code, Charge Type and Billing Basis. Possible combination of Charge Type and Billing Basis as follows:

Billing Basis

| Charge Type | Time | Quantity |
|---|---|---|
| Check In | ✓ | ✓ |
| Check Out | ✓ | ✓ |
| Wash Program | NA | ✓ |
| Wash Count/Turn | NA | ✓ |

Charge Types can also be associated to the Multi-Tier Codes. Tariffs can be mapped to Site/Item 20 depending on the Site Type. If the Site is a Launderette or Distribution Centre, Tariff is mapped to Site. However, if the Site is a Hospital, the Tariff can be mapped to both the Site and the Item 20.

The Alert Management module 226 allows for the setting up of alerts and viewing of alerts. Examples of Exceptions/Alerts are shown in the following table:

| Exception | |
|---|---|
| Type | Scenarios |
| POS Reader | User may forget to tap the start the BIN read process before |
| | placing the first bag in BIN |
| POS Reader | More than one card is placed on the POS reader |
| POS Reader | User may take out RFID card from the POS reader too soon |
| POS Reader | User may leave the RFID card on the POS reader |
| POS Reader | User may repeatedly tap RFID card on the POS reader |
| POS Reader | User may tap a different RFID card before BIN read |
| | process |
| POS Reader | User may tap the same RFID card during BIN read |
| | process |
| POS Reader | User may tap a different RFID card during BIN read |
| | process |
| POS Reader | User may forget to tap the card to end the BIN read |
| | process |
| | (before another user taps his RFID card to start next |
| | session) |
| BIN reader | No action from the user after card is tapped |
| BIN reader | Long lead time to place first bag in BIN |
| BIN reader | User may repeatedly scan the same bag |
| BIN reader | User may introduce more bags before reading of the |
| | previous bag is completed |
| BIN reader | User may drop RFID card into the BIN while reading bags |
| BIN reader | User may take out the bag from BIN before reading is |
| | completed |
| Hardware | Computer may power off or hibernates |
| Hardware | BIN reader may power off |
| Hardware | POS reader may power off |
| Hardware | LED control light may malfunction |
| Hardware | Computer may hand and needs to reboot |
| Hardware | The comm. port for RFID reader to computer is |
| | disconnected |

The report management module 227 enables the following Reports to be generated: Current Stock by Item report, Current Stock by Zone report, Current Stock By Location Type report, Total Stock Breakdown By Item By Status report, Item Wash Count Summary report, and Decommission by Time Period report.

Current Stock by Item report shows a breakdown of the current quantity of the items 20 based on: Site Code, Item Code, Item Category, and Item Status. The report shows total by Item Code, Daily Laundry Check-In/Check-Out report, Average Laundry Turnaround report, Safety Stock Level report.

Current Stock by Zone report shows a breakdown of the current quantity of the items 20 based on: Site Code, Zone Code, Item Code, Item Category, and Item Status. For each item, the report shows subtotal by Zone, total by Site and grand total by item

Current Stock By Location Type report shows a breakdown of the current quantity of the items 20 based on: Site Code, Zone Code, Location Type, Item Code, Item Category, and Item Status. For each item 20, the report shows subtotal by Location Type and Zone, total by Site and grand total by item 20.

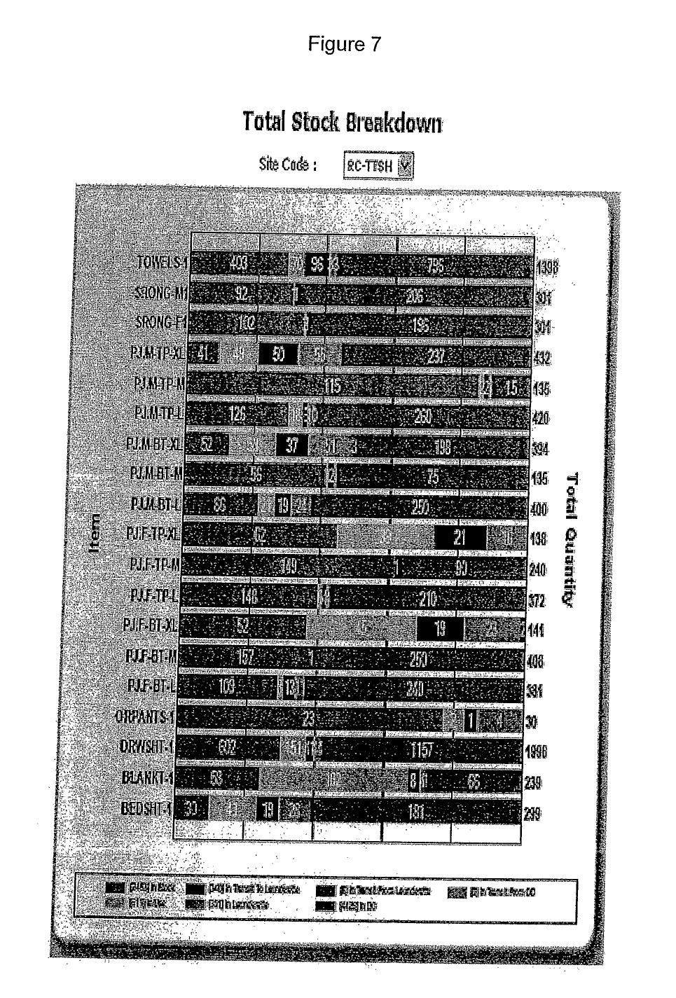

Referring to FIG. 7, Total Stock Breakdown By Item By Status report shows a breakdown of the items 20 in various Item Statuses. Report criteria are: Site Code, Item Category, and Item Status. The report shows the total of the items 20 in the different statuses according to Item Category and Site

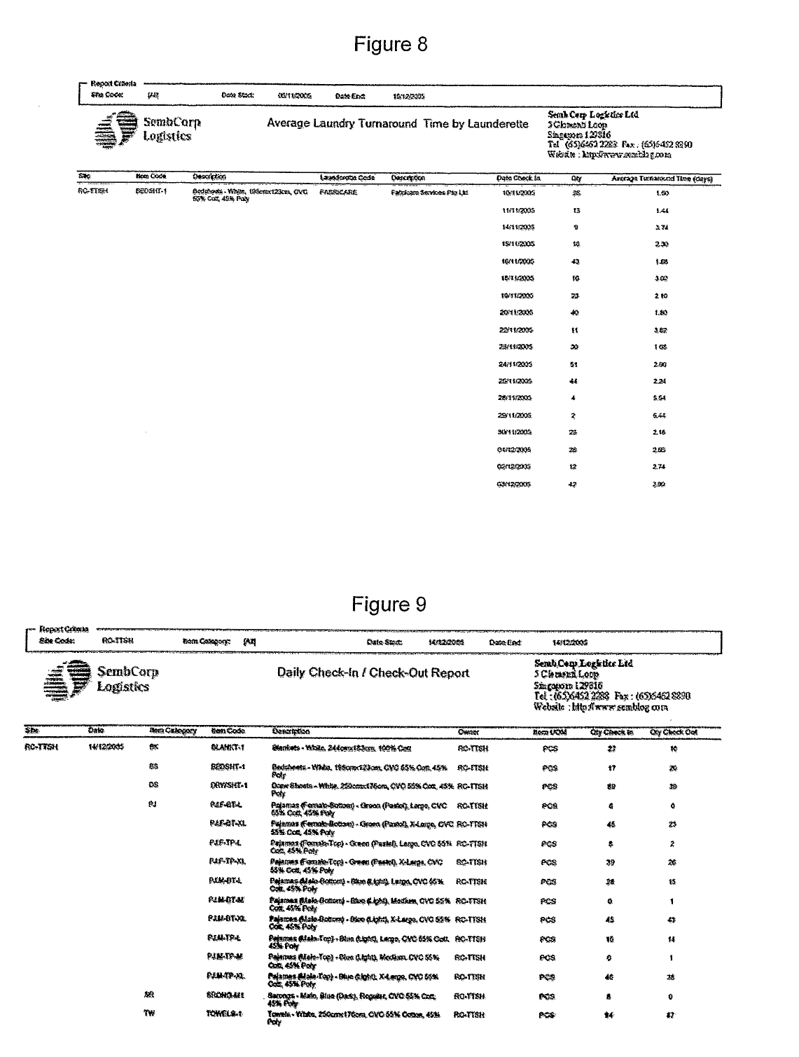

Referring to FIG. 8, Average Laundry Turnaround report refers to the time difference (in number of hours) between the time the items are checked into the Launderette and when they are checked out (Status=‘Clean’, Location=‘In Transit”). This report shows blocks of interval of time and the number of items 20 which are in the launderette for the corresponding number of hours. The Average Laundry Turnaround time during a period is computed by the sum of the length of time the items 20 spent in each launderette divided by the total number of items that is checked in/checked out during the same period. The report criteria are: Site Code, Item Category, Item Status, Date From, Date To, and Interval (in numbers of hours)

Referring to FIG. 9, Daily Laundry Check-In/Check-Out report shows a breakdown of the items 20 that are checked in and checked out of the Site during a selected period. The report criteria are: Site Code, Item Code, Item Category, Item Status, Date From and Date To. This report is applicable to Sites which are ‘Launderette’.

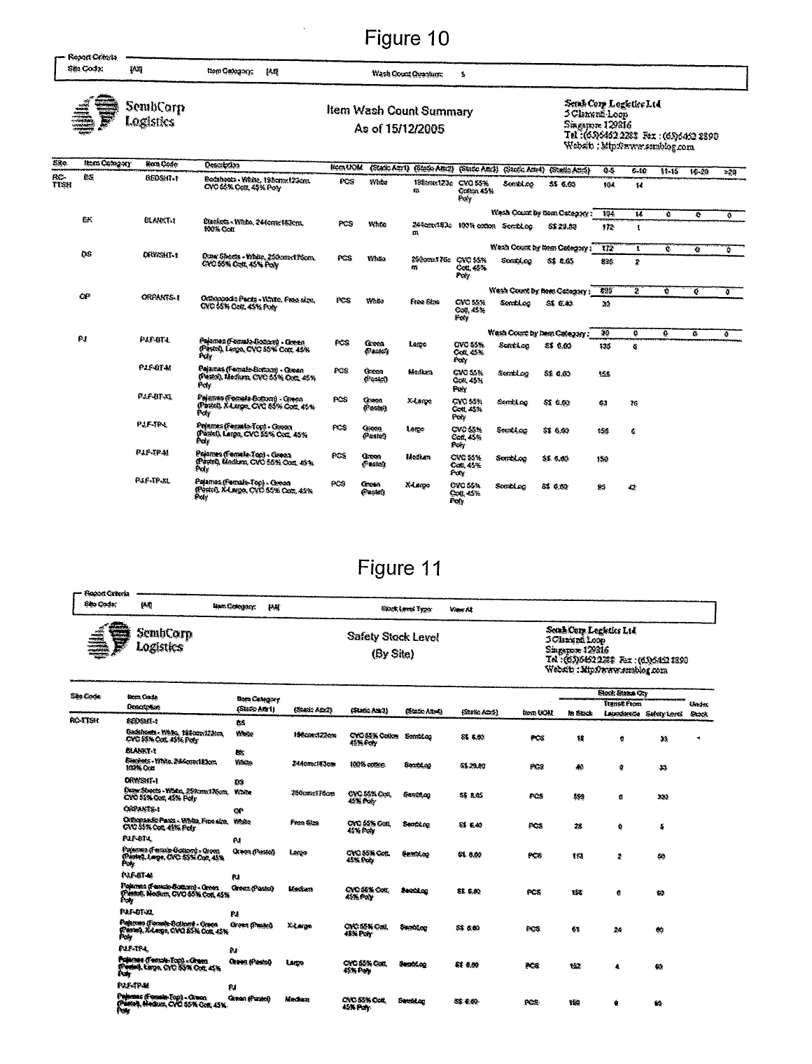

Referring to FIG. 10, Item Wash Count Summary report shows the wash count of the items 20 in various blocks of frequency, as of a selected day. Report criteria are: Site Code, Item Category, Item Status, As of Date and Interval (in number of days). The report shows the total of the Wash Count based on each Item Category.

Referring to FIG. 11, Safety Stock Level report shows the breakdown of each item's available quantity in the respective site and location and the corresponding safety stock level. It also reflects the quantity in transit and an indication if the item is below the safety stock level. The report criteria are: Site Code, Zone Code, Location Type, Item Code, Item Category, Item Status, and Option to “Show All” or “Show Only below Safety Stock”. The report also shows the total of the available quantity, quantity in transit and the safety stock level at the item level for all the locations in each site.

Decommission by Time Period report shows the list of items 20 which are decommissioned, lost or damaged. For each item 20, the report shows details of the item's last known site, location, last wash count and last wash date. It also shows the commission and the decommission date. The report criteria are: Site Code, Decommission Date from and to, Item Code, Item Category, and Item Status

The dashboard module 228 provides a graphical user interface (GUI) when a user logs into the web site to access the system 10. The dashboard module 228 provides a real-time snapshot of individual SKU counts of items 20 at various locations in the supply chain in the closed loop. The dashboard module 228 accesses and retrieves information from the database 204 to provide real-time view of inventory counts of each SKU at the various locations in the supply chain.

Linen items 20 are laundry assets owned by the hospital. The items 20 require tracking, and the system 10 will ascertain the status of an item 20 based on the combination of the tag 25 status and location of item 20:

| Item | Columns | | | |
|---|---|---|---|---|
| Status | Tag.Tag_SiteID | Tag.SiteID | Tag.LocationID | Tag.Status |
| In Stock | = SiteID Passed In | = Tag.Tag_SiteID | | = ‘CL’ |
| In Use | = SiteID Passed In | = Tag.Tag_SiteID | | = ‘IS’ |
| In | = SiteID Passed In | <> | With | |
| Launderette | | Tag.Tag_SiteID | Location_Type | |
| | | and Tag.SiteID | <> 5 (‘In | |
| | | with SiteType = ‘L’ | Transit’) | |
| In DC | = SiteID Passed In | <> | With | |
| | | Tag.Tag_SiteID | Location_Type | |
| | | and Tag.SiteID | <> 5 (‘In | |
| | | with SiteType = ‘D’ | Transit’) | |
| In Transit | = SiteID Passed In | = Tag.Tag_SiteID | With | = ‘SL’ |
| To | | | Location_Type | |
| Launderette | | | = 5 (‘In Transit’) | |
| In Transit | = SiteID Passed In | <> | With | = ‘CL’ |
| From | | Tag.Tag_SiteID | Location_Type = | |
| Launderette | | and Tag.SiteID | 5 (‘In Transit’) | |
| | | with SiteType = ‘L’ | | |
| In Transit | = SiteID Passed In | <> | With | = ‘CL’ |
| From DC | | Tag.Tag_SiteID | Location_Type = | |
| | | and Tag.SiteID | 5 (‘In Transit’) | |
| | | with SiteType = ‘D’ | | |

There are seven types of item status. The information is presented in graphical form and textual form to allow user to have an overview of the breakdown of the laundry items 20. The description of the various columns as follows:
Tag.Tag_SiteID—this is the owner of the laundry item 20.
Tag.SiteID—this is the site whereby the tag 25/item 20 is in.
Tag.LocationID—this is the actual location of the tag 25/item 20 in the Tag.SiteID.
Tag.Status—this is the status of the tag 25.

The system 10 also keeps track of the wash cycle of the item 20 and the last wash date of the item 20.

After the tag 25 is commissioned, the tag 25/item 20 can be checked in/out or issued as illustrated in the following table:

| S/ | Tag | | Location | | Program/ |
|---|---|---|---|---|---|
| No | SiteID | Site ID | ID | Status | Process |
| 1. | Hospital | Any | Any | Open | System |
| | | | | | Admin/Tag |
| 2. | Hospital | Any | Any | Commissioned | Commissioning |
| 3. | Hospital | Hospital | Check | Clean | Check In |
| | | | In | | |
| 4. | Hospital | Hospital | Ward | Issue | Issue |
| 5. | Hospital | Hospital | Check | Soiled | Check Out |
| | | | Out | | |
| 6. | Hospital | Launderette | Check | Soiled | Check In |
| | | | In | | |
| 7. | Hospital | Launderette | Check | Clean | Check Out |
| | | | Out | | |

After commissioning a tag 25, any of the scenarios from 3 to 7 above may occur. That is, items 20 can immediately be checked in to the hospital or checked into the launderette for cleaning, etc.

The following table depicts the various exceptions handled by system 10 related to workflow and also the proposed resolution plan if the exception is reported:

| S/No | Description of Exception | Resolution Plan |
|---|---|---|
| 1. | Item 20 not commissioned | Note down the Tag ID and the current |
| | Tag status is ‘Open’ or | site and location |
| | ‘Decommission’ or | Search for the Item at the site and |
| | ‘Lost’ or ‘Damaged’ | location using handheld |
| | Tag ID not found in Tag | Run user intervention windows-based |
| | master table | client 50 to commission the tag 25 |
| | | accordingly |
| | | Re-introduce the item 20 back to the |
| | | supply chain at the appropriate point by |
| | | checking in/checking out/issue accordingly |
| 2. | Item not belonging to the | Note down the Tag ID, check in location |
| | hospital | and item code |
| | Tag_SiteID <> SiteID of | Search for the Item at the check in store |
| | bin reader | using handheld |
| | | Re-introduce the item back to the supply |
| | | chain at the appropriate point by: |
| | | Check in at the right hospital OR |
| | | Check in to the launderette OR |
| | | Check in to the DC |
| 3. | The status of item before | Note down the Tag ID, check in |
| | check in is ‘Issue’ | location, item code, previous location id |
| | (Please note that this could | Search for the Item at the check in store |
| | be return from ward store, | using handheld |
| | however, since system not | Need to confirm whether the item is |
| | able to differentiate return | returned from ward store (i.e. still clean) |
| | or exception, system will | or supposed to check out for cleaning |
| | flag as exception. SOP | but accidentally check in |
| | should be in place to | If is returned then nothing need to be |
| | prevent issued and used | done, if accidentally check in then check |
| | items check in) | out for cleaning |
| 4. | The status of item before | Note down the Tag ID, check in |
| | check in is ‘Soiled’ | location, item code, previous site and |
| | Previous site and | location id |
| | location id is hospital | Search for the Item at the check in store |
| | and in transit | using handheld |
| | Previous site and | Need to confirm whether the item is |
| | location id is | cleaned, if yes, nothing need to be |
| | launderette and check | done. Otherwise, check out the items |
| | in This could be due to soiled | again for cleaning |
| | items accidentally check in | |
| | to the hospital again or | |
| | missing check out operation | |
| | at launderette or DC. SOP | |
| | should be already in place | |
| | to prevent the first case. | |
| 5. | The status of item before | Note down the Tag ID, check in |
| | check in is not equal to | location, item code, previous site and |
| | ‘Soiled’ | location id |
| | Tag status is ‘Clean’ | Need to monitor whether this happen |
| | Tag status is ‘Issue’ | frequently for the original site |
| | This could due to item not | Continue with the wash process and |
| | check out properly at hospital | check out the item from launderette accordingly |
| | Please note that if tag | |
| | status is ‘Commission’ no | |
| | exception is raised | |
| 6. | The status of item before | Note down the Tag ID, check in |
| | check in is not equal to | location, item code, previous site and |
| | ‘Clean’ | location id |
| | Tag status is ‘Soiled’ | Search for the item in the DC using |
| | Tag status is ‘Issue’ | handheld |
| | This could due to item not | Need to confirm item whether the item is |
| | check in to launderette, | cleaned, if yes, nothing needs to be |
| | directly send from hospital | done. Otherwise, check in at launderette |
| | to DC or not check out from | for cleaning. Please note that there is |
| | launderette | exception raise with reason code |
| | Please note that if tag | CIL001 as the status is ‘Clean‘, |
| | status is ‘Commission’ no | however, in this case there will need no |
| | exception is raised | further action. |
| 7. | Item not belonging to the | Note down the Tag ID, check out |
| | hospital | location and item code |
| | Tag_SiteID <> SiteID of | Continue to send the item for cleaning |
| | bin reader | The audit check process implanted at |
| | | Launderette at packing area will |
| | | highlight any mixing items from different hospitals |
| | | If there is any mixing of items from |
| | | different hospitals, user to note down |
| | | the Tag ID and separate the item out by |
| | | using handheld |
| | | Check out the item as per normal work flow |
| 8. | The status of items before | Note down the Tag ID, check out |
| | check out is not equal to | location, item code, previous site and |
| | ‘Soiled’ | previous location id |
| | Tag status is ‘Clean’ | Need to monitor closely whether this |
| | Tag status is ‘Issue’ | happen frequently for the originated site |
| | This could due to item not | There is nothing to be followed out on |
| | check out properly from | the handling (launderette should already |
| | hospital and not check in | have SOP to ensure items leaving the |
| | properly at launderette | facility is definitely clean) |
| | Please note that if tag | |
| | status is ‘Commission’ no | |
| | exception is raised | |
| 9. | The status of items before | Note down the Tag ID, check out |
| | check out is not equal to | location, item code, previous site and |
| | ‘Clean’ | previous location id |
| | Tag status is ‘Soiled’ | Need to monitor closely whether this |
| | Tag status is ‘Issue’ | happen frequently for the originated site |
| | This could due to item not | There is nothing to be followed out on |
| | check out properly at | the handling (DC should already have |
| | launderette and check in | SOP to ensure items coming into DC |
| | properly at DC | should be ‘Clean’) |
| | Please note that if tag | |
| | status is ‘Commission’ no | |
| | exception is raised | |
| 10. | The status of items before | Note down the Tag ID, issue location, |
| | issue is not equal to ‘Clean’ | item code, previous location id |
| | Tag status is ‘Soiled’ | Search for the Item at the issue store |
| | Tag status is ‘Issue’ | using handheld |
| | This could due to item | Need to confirm whether the item is re- |
| | check out accidentally | issued (i.e. still clean) or supposed to |
| | brought back to issue to | check out for cleaning but accidentally |
| | ward or item already issued | issued to ward store |
| | but being scanned again | If is re-issued then nothing need to be |
| | Please note that if tag | done, if accidentally issue soiled item |
| | status is ‘Commission’ no | then check out for cleaning |
| | exception is raised | |

In addition to the exception handling above, there is also a background process that runs at specific time interval to check on tags 25 that have no movement for a particular number of days. This time interval is configurable by users at enterprise or item level. The definition of no movement is that there is no change of status or location of the tag 25. In such a case, the system 10 uses the last updated timestamp of the tag 25 and compares it with the current date. If the difference is greater or equal to the number of days specified, the system 10 raises an exception for the tag 25.

Although a container 104 with an RFID reader 121 for detecting multiple RFID tags 25 attached to items contained in the container 104 is described (a 3D scanner), it possible for the system 10 to function without a container 104. In substitute, an RFID scanner such as a tunnel/chute type RFID antenna, tabletop scanner or a handheld RFID scanner may be used. Preferably, multiple items 20 are scanned but the system 10 also allows for one item 20 to be scanned at a time.

Although the smart card reader 105, RFID reader 121, the container 104, router 101, N/W switch 102 and client 103 have been described as individual components, they may be provided together. For example, the container 104 may provide a single housing for all components of the client 100 to reduce clutter and space.

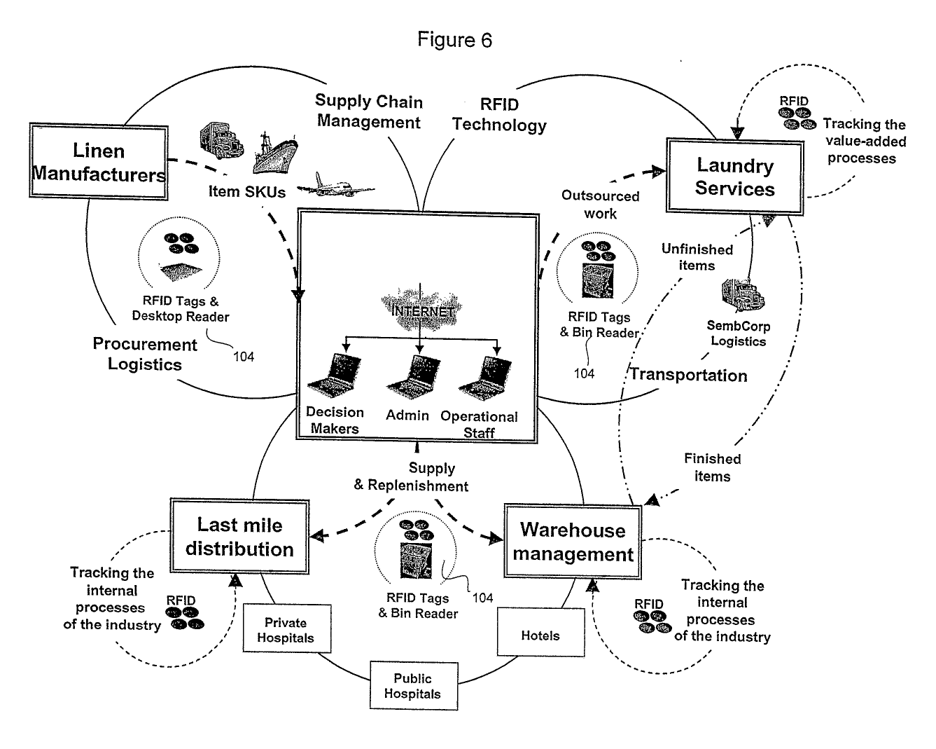

Referring to FIG. 6, the system 10 may be deployed for the entire linen industry from linen manufacturers to end users.

Although the linen industry has been described, it is envisaged that the present invention may be used for any closed loop system for any industry where generic items are circulated in the closed loop. For example, linen at hotels, and military supplies such as lifejackets or parachutes for the military.

It is appreciated by persons skilled in the art that numerous variations and/or modifications may be made to the invention as shown in the specific embodiments without departing from the scope or spirit of the invention as broadly described. The present embodiments are, therefore, to be considered in all respects illustrative and not restrictive.

We claim:

1. A system for tracking generic items in a closed loop, the system comprising:
a plurality of clients, each client automatically generating and transmitting item information relating to the items identified by the client; and
a server to receive the item information from a plurality of clients and to aggregate the circulation of the items in the closed loop, the item information being stored in a database connected to the server;
wherein the item information comprises:
information identifying the client;
information identifying each item obtained from a Radio Frequency Identification (RFID) tag attached to the item and time each item was identified by a RFID reader operatively connected to the client, and
information identifying a user causing the RFID tag to be identified.

2. The system according to claim 1, wherein the RFID reader is operatively connected to at least one RFID antenna that is provided in a container, the container for containing items, and when items are placed or removed from the container, the RFID tags of all items contained in the container are identified.

3. The system according to claim 1, wherein the RFID reader detects multiple RFID tags of multiple items at the same time.

4. The system according to claim 1, wherein the items are items of linen used in a hospital or hotel.

5. The system according to claim 1, further comprising an administration client module for configuring the system and associating items and associated items details information on the server with RFID tag identification codes, the item details information including the name and type of the item, the size of the item, the date of purchase of the item, the purchase price of the item, and also for configuring security features including user access rights and data view restrictions.

6. The system according to claim 1, wherein the server comprises a report management module to provide predetermined reports on the status of items, the predetermined reports being any one from the group consisting of: dwell time of stationery items, usage of the items, age of the items, location of items according to the type of an item, average circulation time according to the type of an item, movement history of an item, total stock breakdown of items, current stock by item, current stock by zone, current stock by location type, item wash count summary, items transacted by users, and decommission by time period report.

7. The system according to claim 1, wherein the server comprises an electronic invoicing module to enable service providers to charge differentiated rates by service types or Stock Keeping Units (SKUs), or on time of delivery/turnaround time.

8. The system according to claim 7, wherein invoice generation is automated and based on information collected from reading the RFID tags of the items.

9. The system according to claim 1, wherein the server comprises a dashboard module that retrieves the item information from the database to provide a real-time snapshot of inventory counts of each Stock Keeping Unit (SKU) at predetermined locations in the closed loop.

10. The system according to claim 1, wherein items identified by the RFID reader are stored in a local database of the client to enable off line audit and cycle counts.

11. The system according to claim 1, wherein the system is fully automated and is a paperless transaction system without manual keyboard entry for recording the movement of items in the closed loop.

12. The system according to claim 1, wherein the information identifying a user is obtained from a card device of the user using a card device reader operatively connected to each client.

13. The system according to claim 12, wherein the card device is a contactless smart card.

14. The system according to claim 12, wherein each card device has a unique identification code, each identification code being associated with a user.

15. The system according to claim 1, wherein the information identifying the client is associated to the location of the RFID reader.

16. The system according to claim 1, wherein each RFID tag has a unique identification code, each identification code being associated with a specific item of linen.

17. The system according to claim 1, wherein the clients are classified into predetermined groups according to logic, process step, or location.

18. The system according to claim 1, wherein the server comprises an alert management module to create alerts and view created alerts.

19. The system according to claim 1, wherein an alert is any one from the group consisting of: low inventory levels of a type of item at a location, repeated failure of a user to identify themself when causing the RFID tag to be identified, if a specific node or process is skipped, and no movement of an item from a location for a predetermined period of time.

20. The system according to claim 1, wherein system is provided based on an Application Service Provider (ASP) model, the database and the server being hosted by an application service provider.

21. The system according to claim 1, wherein the system monitors multiple enterprises and supply chains at the same time.

22. The system according to claim 1, wherein revenue is generated by the system using a transaction model or lease model.

23. A client for tracking generic items in a closed loop, the client comprising:
a data capture module to capture identification information from RFID tags attached to the items and identification information from a card device of a user;
a data processing module to associate the identification information of the RFID tags and card device with the time the identification information was captured and identity of the client; and
a data transmission module to transmit the data processed by the data processing module to a data receiving module at a server to aggregate the circulation of the items in the closed loop from multiple clients.

24. The client according to claim 23, wherein the data capture module is operatively connected to an RFID reader to capture identification information from the RFID tags.

25. The client according to claim 24, wherein the RFID reader is operatively connected to at least one RFID antenna that is provided in a container, the container for containing items, and when items are placed or removed from the container, the RFID tags of all items contained in the container are identified.

26. The client according to claim 24, wherein the RFID reader is a RFID scanner device such as a 3D scanner, tunnel/chute type RFID antenna, tabletop scanner or a handheld RFID scanner.

27. The client according to claim 25, wherein the data capture module captures the identification information when items are placed into or removed from the container.

28. The client according to claim 24, further comprising RFID middleware to filter unique reads from the RFID reader per scan and to associate each scan with a card device of a user performing the scan.

29. The client according to claim 23, the card device is a contactless smart card.

30. A container for containing linen items operatively connected to a client for tracking the linen items in a closed loop, the container comprising:
a plurality of antennas to detect RF signals emitted by RFID tags attached to the linen items contained in the container; and
a multiplexer to multiplex the RF signals for transmission to an RFID reader;
wherein each of the plurality of antenna is positioned in the sidewall of the container at a predetermined position to improve detection accuracy of the RFID tags attached to the linen items contained in the container.

31. The container according to claim 30, wherein the client comprises RFID middleware to filter unique reads from the RFID reader per scan and to associate each scan with a card device of a user performing the scan.

32. A server for tracking generic items in a closed loop, the server comprising:
a data receiving module to receive item information from a plurality of clients; and
an aggregation module to aggregate the circulation of the items in the closed loop based on the received item information;
wherein the item information comprises:
information identifying the client;
information identifying each item obtained from a Radio Frequency Identification (RFID) tag attached to the item and time each item was identified by a RFID reader operatively connected to the client, and
information identifying a user causing the RFID tag to be identified.

33. The server according to claim 32, further comprising a report management module to provide predetermined reports on the status of items, the predetermined reports being any one from the group consisting of: dwell time of stationery items, usage of the items, age of the items, location of items according to the type of an item, average circulation time according to the type of an item, movement history of an item, total stock breakdown of items, current stock by item, current stock by zone, current stock by location type, item wash count summary, items transacted by users, and decommission by time period report.

34. The server according to claim 32, wherein the client comprises:
a data capture module to capture identification information from RFID tags attached to the items and identification information from a card device of a user;
a data processing module to associate the identification information of the RFID tags and card device with the time the identification information was captured and identity of the client; and
a data transmission module to transmit the data processed by the data processing module to the data receiving module at the server to aggregate the circulation of the items in the closed loop from multiple clients.
